(19) United States
(12) Patent Application Publication
(10) Pub. No.: US 2015/0353718 A1
(43) Pub. Date: Dec. 10, 2015

(54) A BLEND COMPOSITION SUITABLE FOR INJECTION MOLDING APPLICATIONS

(71) Applicant: DOW GLOBAL TECHNOLOGIES LLC, Midland, MI (US)

(72) Inventors: Laura B. Weaver, Lake Jackson, TX (US); Jeffrey C. Munro, Bellaire, TX (US); Kim L. Walton, Lake Jackson, TX (US); Juan C. Tuberquia, Manvel, TX (US); Santosh S. Bawiskar, Sugar Land, TX (US)

(21) Appl. No.: 14/762,485

(22) PCT Filed: Feb. 28, 2014
(86) PCT No.: PCT/US14/19259

§ 371 Date: Jul. 22, 2015

Related U.S. Application Data
(60) Provisional application No. 61/770,717, filed on Feb. 28, 2013.
(60) Provisional application No. 61/882,095, filed on Sep. 25, 2013.

(51) Int. Cl. C08L 23/10

(52) U.S. Cl. CPC C08L 23/10

(57) ABSTRACT

The instant invention provides a blend composition suitable for injection molded articles. The blend composition suitable for injection molded article according to the present invention comprises: (a) from 50 to 80 percent by weight of a propylene/α-olefin interpolymer composition; (b) from 5 to 25 percent by weight of a homopolymer polypropylene, a random copolymer polypropylene, clarified random copolymer polypropylene, and combination thereof; and (c) from 5 to 39 percent by weight of a plasticizing agent; wherein said blend composition has a total haze of less than 25 percent.

### REFERENCE TO RELATED APPLICATIONS

This present application claims the benefit of U.S. Provisional Application No. 61/770,717, filed Feb. 28, 2013, and the benefit of U.S. Provisional Application No. 61/882,095, filed Sep. 25, 2013.

### FIELD OF INVENTION

The instant invention relates to a blend composition suitable for injection molding applications.

### BACKGROUND OF THE INVENTION

Clear flexible polyvinyl chloride (PVC) is typically used in sporting goods, housewares, and fashion footwear and consumers products. However, PVC requires plasticizers for processability and softness. Many PVC plasticizers are phthalate based materials, which are increasingly under scrutiny in skin contact application.

Therefore, there is a need for blend composition that reduces the need for phthalate plasticizers and provides acceptable haze properties

### SUMMARY OF THE INVENTION

The instant invention provides a blend composition suitable for injection molded articles.

In one embodiment, the instant invention provides a blend composition suitable for injection molding applications comprising: (a) from 50 to 80 percent by weight of a propylene/α-olefin interpolymer composition; (b) from 5 to 25 percent by weight of a homopolymer polypropylene, a random copolymer polypropylene, clarified random copolymer polypropylene, and combination thereof; and (c) from 5 to 35 percent by weight of a plasticizing agent; wherein said blend composition has a total haze of less than 25 percent.

In an alternative embodiment, the instant invention further provides a process for making an injection molded article comprising the steps of: (a) selecting from 50 to 80 percent by weight of a propylene/α-olefin interpolymer composition; (b) selecting from 5 to 25 percent by weight of a homopolymer polypropylene, a random copolymer polypropylene, clarified random copolymer polypropylene, and combination thereof; (c) selecting from 5 to 35 percent by weight of a plasticizing agent; (d) contacting said a-c components in the presence of heat; (e) thereby forming a blend composition, wherein said blend composition has a total haze of less than 25 percent; and (f) forming said blend composition into a molded article.

In another alternative embodiment, the instant invention further provides a transparent injection molded article, e.g. consumer goods such shoes, e.g. jelly shoes, boots, housewares, grips, and the like.

### DETAILED DESCRIPTION OF THE INVENTION

The instant invention provides a blend composition suitable for injection molded articles. The blend composition suitable for injection molding applications according to the present invention comprises: (a) from 50 to 80, further from 55 to 75, further from 60 to 70 percent by weight of a propylene/α-olefin interpolymer composition; (b) from 5 to 25, further from 7 to 20, further from 8 to 15 percent by weight of a homopolymer polypropylene, a random copolymer polypropylene, clarified random copolymer polypropylene, and combination thereof; and (c) from 5 to 39, further from 5 to 37, further from 5 to 35, percent by weight of a plasticizing agent; wherein said blend composition has a total haze of less than 25 percent, further less than, or equal to, 23 percent. Each weight percent is based on the weight of the blend composition.

The blend composition can have a Hardness, Shore A in the range of from 50 to 90, for example from 50 to 75. The blend composition can also have a melt flow rate, measured at 190° C. and 2.16 kg, in the range of from 8 to 70 g/10 minutes, for example from 10 to 25 g/10 minutes. The blend composition can also have a fingerprint, after aging at 70° C. for one week, of 1 or 2. The blend composition can also have a haze of less than 25%, after said blend composition being aged in an oven at 55° C., or above, for at least 5 consecutive days.

In one embodiment, the blend composition comprises from 10 to 39, further from 10 to 37, further from 10 to 35, further from 10 to 30, percent by weight, of the plasticizing agent.

In one embodiment, the blend composition comprises from 15 to 39, further from 15 to 37, further from 15 to 35, further from 15 to 30, percent by weight, of the plasticizing agent.

In one embodiment, the blend composition comprises from 20 to 39, further from 20 to 37, further from 20 to 35, further from 20 to 30, percent by weight, of the plasticizing agent.

In one embodiment, the blend composition comprises greater than, or equal to 96 weight percent of components (a) and (b), based on the total weight of polymer components in the blend composition. In a further embodiment, the blend composition comprises greater than, or equal to 97 weight percent of components (a) and (b), based on the total weight of polymer components in the blend composition. In a further embodiment, the blend composition comprises greater than, or equal to 98 weight percent of components (a) and (b), based on the total weight of polymer components in the blend composition.

In one embodiment, the blend composition has a density from 0.85 to 0.91 g/cc, further from 0.86 to 0.90 g/cc, further from 0.87 to 0.89 g/cc (1 cc=1 cm³).

In one embodiment, the blend composition has a melt index (230° C.; 2.16 kg) from 5 to 100 g/10 min, further from 10 to 90 g/10 min, further from 18 to 80 g/10 min.

In one embodiment, the blend composition has a Tc greater than 80° C., further greater than, or equal to, 81° C., as determined by DSC.

In one embodiment, the blend composition does not comprise a filler.

In one embodiment, the blend composition does not comprise an ethylene/alpha-olefin copolymer, where the alpha-olefin is a C3 to C20 alpha-olefin. An ethylene/alpha-olefin copolymer comprises a majority amount of polymerized ethylene, based on the weight of the polymer, and an alpha-olefin, as the only monomer types. In a further embodiment, the blend composition does not comprise an ethylene/alpha-olefin interpolymer, where the alpha-olefin is a C3 to C20 alpha-olefin. An ethylene/alpha-olefin inerpolymer comprises a majority amount of polymerized ethylene, based on the weight of the polymer, and an alpha-olefin. In a further embodiment, the blend composition does not comprise an ethylene-based polymer. An ethylene-based polymer comprises a majority amount of polymerized ethylene, based on the weight of the polymer.

In one embodiment, the blend composition does not comprise an ethylene/alpha-olefin copolymer, where the alpha-olefin is a C4 to C20 alpha-olefin. An ethylene/alpha-olefin copolymer comprises a majority amount of polymerized ethylene, based on the weight of the polymer, and an alpha-olefin, as the only monomer types. In a further embodiment, the blend composition does not comprise an ethylene/alpha-olefin interpolymer, where the alpha-olefin is a C4 to C20 alpha-olefin. An ethylene/alpha-olefin interpolymer comprises a majority amount of polymerized ethylene, based on the weight of the polymer, and an alpha-olefin. In a further embodiment, the blend composition does not comprise an ethylene-based polymer. An ethylene-based polymer comprises a majority amount of polymerized ethylene, based on the weight of the polymer.

The blend composition may comprise a combination of two or more embodiments or features as described herein.

### Propylene/α-Olefin Interpolymer Composition (PBE)

The blend composition suitable for injection molded article according to the present invention comprises from 50 to 80 percent by weight of a propylene/α-olefin interpolymer composition (PBE), for example from 55 to 65 weight percent. The propylene/α-olefin interpolymer composition comprises a propylene/alpha-olefin copolymer, and may optionally further comprise one or more polymers, e.g. a random copolymer polypropylene (RCP). In one particular embodiment, the propylene/alpha-olefin copolymer is characterized as having substantially isotactic propylene sequences. “Substantially isotactic propylene sequences” means that the sequences have an isotactic triad (mm) measured by ¹³C NMR of greater than about 0.85; in the alternative, greater than about 0.90; in another alternative, greater than about 0.92; and in another alternative, greater than about 0.93. Isotactic triads are well-known in the art and are described in, for example, U.S. Pat. No. 5,504,172 and International Publication No. WO 00/01745, which refers to the isotactic sequence in terms of a triad unit in the copolymer molecular chain determined by ¹³C NMR spectra.

The propylene/alpha-olefin copolymer may have a melt flow rate in the range of from 0.1 to 25 g/10 minutes, measured in accordance with ASTM D-1238 (at 230° C./2.16 Kg). All individual values and subranges from 0.1 to 25 g/10 minutes are included herein and disclosed herein; for example, the melt flow rate can be from a lower limit of 0.1 g/10 minutes, 0.2 g/10 minutes, 0.5 g/10 minutes, 2 g/10 minutes, 4 g/10 minutes, 5 g/10 minutes, 10 g/10 minutes, or 15 g/10 minutes to an upper limit of 25 g/10 minutes, 20 g/10 minutes, 18 g/10 minutes, 15 g/10 minutes, 10 g/10 minutes, 8 g/10 minutes, or 5 g/10 minutes. For example, the propylene/alpha-olefin copolymer may have a melt flow rate in the range of from 0.1 to 20 g/10 minutes; or from 0.1 to 18 g/10 minutes; or from 0.1 to 15 g/10 minutes; or from 0.1 to 12 g/10 minutes; or from 0.1 to 10 g/10 minutes; or from 0.1 to 5 g/10 minutes; or from 0.1 to 2 g/10 minutes.

The propylene/alpha-olefin copolymer has a crystallinity in the range of from at least 1 percent by weight (a heat of fusion of at least 2 Joules/gram) to 20 percent by weight (a heat of fusion of less than 33 Joules/gram). All individual values and subranges from 1 percent by weight (a heat of fusion of at least 2 Joules/gram) to 20 percent by weight (a heat of fusion of less than 33 Joules/gram) are included herein and disclosed herein; for example, the crystallinity can be from a lower limit of 1 percent by weight (a heat of fusion of at least 2 Joules/gram), 2.5 percent (a heat of fusion of at least 4 Joules/gram), or 3 percent (a heat of fusion of at least 5 Joules/gram) to an upper limit of 20 percent by weight (a heat of fusion of less than 33 Joules/gram), 16 percent by weight (a heat of fusion of less than 26 Joules/gram), 12 percent by weight (a heat of fusion of less than 20 Joules/gram) or 7 percent by weight (a heat of fusion of less than 11 Joules/gram). For example, the propylene/alpha-olefin copolymer may have a crystallinity in the range of from at least 1 percent by weight (a heat of fusion of at least 2 Joules/gram) to 20 percent by weight (a heat of fusion of less than 33 Joules/gram); or in the alternative, the propylene/alpha-olefin copolymer may have a crystallinity in the range of from at least 1 percent by weight (a heat of fusion of at least 2 Joules/gram) to 15 percent by weight (a heat of fusion of less than 24.8 Joules/gram); or in the alternative, the propylene/alpha-olefin copolymer may have a crystallinity in the range of from at least 1 percent by weight (a heat of fusion of at least 2 Joules/gram) to 7 percent by weight (a heat of fusion of less than 11 Joules/gram); or in the alternative, the propylene/alpha-olefin copolymer may have a crystallinity in the range of from at least 1 percent by weight (a heat of fusion of at least 2 Joules/gram) to 5 percent by weight (a heat of fusion of less than 8.3 Joules/gram). The crystallinity is measured via Differential scanning calorimetry (DSC) method.

The propylene/alpha-olefin copolymer has a DSC melting point (second heat) of less than 80° C., for example, from 25 to 75° C., or in the alternative, between 40 and 70° C.

The propylene/alpha-olefin copolymer comprises units derived from propylene and polymeric units derived from one or more alpha-olefin comonomers. Exemplary comonomers utilized to manufacture the propylene/alpha-olefin copolymer are C₂, and C₄ to C₁₀ alpha-olefins; for example, C₂, C₄, C₆ and C₈ alpha-olefins.

The propylene/alpha-olefin copolymer comprises from 9 to 40 percent by weight of units derived from one or more alpha-olefin comonomers. All individual values and subranges from 9 to 40 weight percent are included herein and disclosed herein; for example, the weight percent of units derived from one or more alpha-olefin comonomers can be from a lower limit of 9, 10, 11, 12 or 13 weight percent to an upper limit of 40, 35, 30, 27, 20, or 15 weight percent. For example, the propylene/alpha-olefin copolymer comprises from 9 to 35 percent by weight of units derived from one or more alpha-olefin comonomers; or in the alternative, the propylene/alpha-olefin copolymer comprises from 10 to 25 percent by weight of units derived from one or more alpha-olefin comonomers; or in the alternative, the propylene/alpha-olefin copolymer comprises from 10 to 20 percent by weight of units derived from one or more alpha-olefin comonomers; or in the alternative, the propylene/alpha-olefin copolymer comprises from 10 to 15 percent by weight of units derived from one or more alpha-olefin comonomers.

The propylene/alpha-olefin copolymer has a molecular weight distribution (MWD), defined as weight average molecular weight divided by number average molecular weight (M_{w}/Mₙ) of 3.5 or less; in the alternative 3.0 or less; or in another alternative from 1.8 to 3.0.

Such propylene/alpha-olefin copolymers are further described in details in the U.S. Pat. Nos. 6,960,635 and 6,525,157, incorporated herein by reference. Such propylene/alpha-olefin copolymers are commercially available from The Dow Chemical Company, under the tradename VERSIFY™, or from ExxonMobil Chemical Company, under the tradename VISTAMAXX™.

In one embodiment, the propylene/alpha-olefin copolymers are further characterized as comprising (A) between 60 and less than 91, preferably between 80 and 90 and more preferably between 85 and 90, weight percent units derived from propylene, and (B) between 9 and 40, preferably between 10 and 20, and more preferably between 10 and 15, weight percent units derived from at least one of ethylene and/or a C₄₋₁₀ α-olefin; and containing an average of at least 0.001, preferably an average of at least 0.005 and more preferably an average of at least 0.01, long chain branches/1000 total carbons. The maximum number of long chain branches in the propylene/alpha-olefin copolymer is not critical, but typically it does not exceed 3 long chain branches/1000 total carbons. The term long chain branch, as used herein with regard to propylene/alpha-olefin copolymers, refers to a chain length of at least one (1) carbon more than a short chain branch, and short chain branch, as used herein with regard to propylene/alpha-olefin copolymers, refers to a chain length of two (2) carbons less than the number of carbons in the comonomer. For example, a propylene/1-octene interpolymer has backbones with long chain branches of at least seven (7) carbons in length, but these backbones also have short chain branches of only six (6) carbons in length. Such propylene/alpha-olefin copolymers are further described in details in the U.S. Provisional Patent Application No. 60/988,999 and International Patent Application No. PCT/US08/082599, each of which is incorporated herein by reference.

### Other Polymeric Components

The blend composition suitable for injection molding applications according to the present invention comprises from 5 to 25 percent by weight of a homopolymer polypropylene, a random copolymer polypropylene, clarified random copolymer polypropylene, and combination thereof, for example from 10 to 20 weight percent. In a further embodiment, such homopolymer polypropylenes, a random copolymer polypropylenes, and clarified random copolymer polypropylenes have a DSC melting point temperature of from greater than 120° C., for example from 140° C. to 165° C.

### Plasticizing Agent(s)

The blend composition suitable for injection molded articles according to the present invention comprises from 5 to 35 percent by weight of one or more plasticizing agent, for example from 10 to 30 weight percent, or in the alternative from 20 to 30 weight percent.

The plasticizing agent can be an oil. The oil can be an aromatic oil, a mineral oil, a naphthenic oil, a paraffinic oil, a triglyceride-based vegetable oil such as castor oil, a synthetic hydrocarbon oil such as polypropylene oil, a silicone oil, or any combination thereof.

White mineral oils are preferred. The oil is a hydrocarbon oil, often referred to as a white mineral oil, or alternatively as a polymer or a processing oil. These oils are chemically defined as hydrotreated heavy paraffinic distillates or a white mineral oil. The oils of most utility have little to no aromatic content, from 50 to 90% paraffinic content, and from 10 to 50% naphthenic content, and most preferably from 65 to 75% paraffinic content and from 25 to 35% naphthenic content. Such plasticizing agent can have a viscosity in the range of from 12 to 70, for example from 15 to 55, cSt at 40° C., measured according to ASTM D-445, and further is an oil.

Such plasticizing agents include, but are not limited to, mineral oils such as hydrocarbon mineral oils, e.g. PARALUX 6001R, available from ChevronTexaco; HYDROBRITE 550, available from Sonneborn, Inc. LP 200, available from Sonneborn; INDOPOL H-15, available from INEOS, RISELLA X 420, available from Shell Deutschland Oil GmbH, PLASTHALL 100, available from The HallStar Company.

The mineral oil can be a white mineral oil having a refractive index in the range of from 1.45 to 1.49, measured according to ASTM-D 1218, having a paraffinic carbon content in the range of 50 to 90 percent, measured according to ASTM-D 3238, having a naphthenic carbon content in the range of 10 to 50 percent, measured according to ASTM-D 3238, and/or a kinematic viscosity at 40° C. in the range of from 15 to 400 cSt, measured according to ASTM-D 445.

### Additional Components

The blend composition suitable for injection molding applications according to the present invention may further comprise one or more additives. Such additives include, but are not limited to, antistatic agents, color enhancers, dyes, lubricants, fillers, pigments, primary antioxidants, secondary antioxidants, processing aids, UV stabilizers, mold release agents, and combinations thereof. The blend composition suitable for injection molded article according to the present invention may contain any amounts of additives. The blend composition may comprise from about 0 to about 25 percent by the combined weight of such additives, based on the weight of the blend composition and the one or more additives.

Mold release agents can comprise Oleamide such as 9-Octadecenamide. The Oleamide can have the following molecular structure:

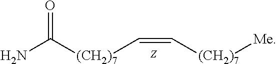

### Process for Making the Blend Composition

The blend composition of the present invention can be prepared via any conventional melt blending process such as extrusion via an extruder, e.g. single or twin screw extruder. The PBE; one or more additional polymeric components selected from the group consisting of a homopolymer polypropylene, a random copolymer polypropylene, clarified random copolymer polypropylene, and combination thereof; one or more plasticizing agents; and optionally one or more additives may be melt blended in any order via one or more extruders to form a uniform blend composition. In the alternative, the PBE; one or more additional polymeric components selected from the group consisting of a homopolymer polypropylene, a random copolymer polypropylene, clarified random copolymer polypropylene, and combination thereof; one or more plasticizing agents; and optionally one or more additives may be dry blended in any order, and subsequently extruded to form an injection molded article.

### End-Use Applications

The inventive blend compositions of the present invention can be formed into transparent injection molded articles, e.g., consumer goods such shoes, e.g. jelly shoes, boots, housewares, grips, and the like, via for example, injection molding process.

In the injection molding process, the inventive blend composition is fed into an extruder via a hopper. The extruder conveys, heats, melts, and pressurizes the inventive blend composition to a form a molten stream. The molten stream is forced out of the extruder under pressure through a nozzle into a relatively cool mold held closed thereby filling the mold. The melt cools and hardens until fully set-up. The mold then opens and the molded article, e.g., shoe, is removed.

### EXAMPLES

The following examples illustrate the present invention but are not intended to limit the scope of the invention.

### Blend Composition Components:

DE 2400.05 is a propylene/ethylene copolymer having a target melt flow rate (at 230° C., 2.16 kg) of 2 g/10 minutes, a target density of 0.863 g/cc.
VERSIFY 2200 is a propylene/ethylene copolymer having a target melt flow rate (at 230° C., 2.16 kg) of 2 g/10 minutes, a DSC melting peak of approximately 82° C., a target density of 0.876 g/cc.
VERSIFY 2300 is a propylene/ethylene copolymer having a target melt flow rate (at 230° C., 2.16 kg) of 2 g/10 minutes, a DSC melting peak of approximately 66° C., a target density of 0.866 g/cc.
VERSIFY 4301 is a propylene/ethylene copolymer having a target melt flow rate (at 230° C., 2.16 kg) of 25 g/10 minutes, a DSC melting peak of approximately 64° C., a target density of 0.866 g/cc.
BRASKEM PP R7021-50RNA is a random-copolymer polypropylene having a target melt flow rate (at 230° C., 2.16 kg) of 50 g/10 minutes.
BRASKEM PP 5D49 is a homopolymer polypropylene having a target melt flow rate (at 230° C., 2.16 kg) of 38 g/10 minutes.
BRASKEM PP H110-02N is a homopolymer polypropylene having a target melt flow rate (at 230° C., 2.16 kg) of 2 g/10 min.
DOW HPDE DMDA-8965 NT 7 is high-density polyethylene having a target melt flow rate (at 190° C., 2.16 kg) of 66 g/10 minutes a target density of 0.954 g/cc.
PARALUX 6001R is a process oil having a target viscosity of 116 cSt at 40° C. (ASTM D-445), a refractive index at 20° C. (ASTM D1218) of 1.4781.
AM Fine AX-71 is an alkyl phosphate-based release agent having an average molecular weight of 490, and a melting point temperature in the range of from 70 to 75° C., which is commercially available from Amfine Chemical Corporation.
LP-200, which is commercially available from Sonneborn, is a white mineral oil having a Specific Gravity in the range of from 0.875 to 0.895 at 60° F./60° F. measured via ASTM D-4052, and a Visc. SAbolt in the range of from 190 to 210 SUS at 100° F. measured via ASTM D-2161 (estimated 41-45 cSt at 40° C. (ASTM D-445)).
CRODAMIDE VRX amides, C18, unsaturated commercially available from Croda.
INDOPOL H-15, which is commercially available from INEOS, is polybutene(isobutylene/butene copolymer in liquid form, CAS No. 9003-29-6.
RISELLA X 420, which is commercially available from Shell Deutschland Oil GmbH, is a process oil, REACH Registration No. 01-0000020163-82-0001.
PLASTHALL 100, which is commercially available from The HallStar Company, is Isooctyl Tallate in liquid form, CAS No. 68333-78-8.

### Inventive Blend Composition 1-8 and Comparative Blend Compositions 1-6

Inventive Blend Composition 1-8 and Comparative Blend Compositions 1-6 were prepared based on formulation components listed in Tables 1A and 1 B, according to the following process. Formulation components reported in Tables 1A and 1B were melt-blended via a twin-screw extruder, ZSK 30 mm extruder, equipped with a water bath and strand cutter, using conditions shown in Table 2.

TABLE 1A

| | Inventive | Inventive | Inventive | Inventive | Inventive | Inventive | Inventive | Inventive |
|---|---|---|---|---|---|---|---|---|
| | Blend | Blend | Blend | Blend | Blend | Blend | Blend | Blend |
| | Comp 1 | Comp 2 | Comp 3 | Comp 4 | Comp 5 | Comp 6 | Comp 7 | Comp 8 |
| DE2400.05 | 65 W % | 64.7 W % | 60 W % | — | 65 W % | 60 W % | 65.4 W % | 54.26 W % |
| VERSIFY | — | — | — | — | — | — | — | |
| 2200 | | | | | | | | |
| VERSIFY | — | — | — | 65 W % | — | — | | |
| 4301 | | | | | | | | |
| BRASKEM | 10 W % | 10 W % | 10 W % | 10 W % | — | 10 W % | 10.89 W % | 10.69 W % |
| PP R7021- | | | | | | | | |
| 50RNA (rcPP) | | | | | | | | |
| BRASKEM | — | — | — | — | 10 W % | — | — | |
| PP 5D49 | | | | | | | | |
| (hPP) | | | | | | | | |
| DOW HPDE | — | — | — | — | — | — | — | |
| DMDA-8965 | | | | | | | | |
| NT 7 | | | | | | | | |
| PARALUX | 25 W % | 25 W % | 30 W % | 25 W % | 25 W % | — | — | 35 W % |
| 6001R oil | | | | | | | | |
| AM Fine AX- | — | 0.3 W % | — | — | — | — | | |
| 71 | | | | | | | | |
| LP-200 | — | — | — | — | — | 30 W % | 20.9 W % | |
| CRODAMIDE | — | — | — | — | — | 0.05 W % | 0.11 W % | 0.05 W % |
| VRX | | | | | | | | |
| INDOPOL H- | — | — | — | — | — | — | | |
| 15 (PIB) | | | | | | | | |
| SIPERNAT | — | — | — | — | — | — | 2.7 W % | |
| 500LS | | | | | | | | |

TABLE 1B

| | Comparative | Comparative | Comparative | Comparative | Comparative | Comparative |
|---|---|---|---|---|---|---|
| | Blend Comp 1 | Blend Comp 2 | Blend Comp 3 | Blend Comp 4 | Blend Comp 5 | Blend Comp 6 |
| DE2400.05 | — | 65 W % | 67.2 | 67.2 | 90 | 48.58 |
| VERSIFY | 65 W % | — | — | — | | |
| 2200 | | | | | | |
| VERSIFY | — | — | — | — | | |
| 4301 | | | | | | |
| BRASKEM | 10 W % | — | 11.2 | 11.2 | | 11.37 |
| PP R7021- | | | | | | |
| 50RNA (rcPP) | | | | | | |
| BRASKEM | — | — | — | — | | |
| PP 5D49 | | | | | | |
| (hPP) | | | | | | |
| DOW HPDE | — | 10 W % | — | — | | |
| DMDA-8965 | | | | | | |
| NT 7 | | | | | | |
| PARALUX | 25 W % | 25 W % | — | — | | |
| 6001R oil | | | | | | |
| AM FINE | — | 0.3 W % | — | — | 0.05 | |
| AX-71 | | | | | | |
| LP-200 | — | — | 21.5 | 8.1 | | 40 |
| CRODAMIDE | — | — | 0.11 | 0.11 | | 0.05 |
| VRX | | | | | | |
| INDOPOL H- | — | — | — | 13.4 | | |
| 15 (PIB) | | | | | | |
| SIPERNAT | — | — | — | — | | |
| 500LS | | | | | | |
| H110-02 PP (2 | — | — | — | — | 9.95 | |
| MFR) | | | | | | |

TABLE 2

| | |
|---|---|
| Zone 1 Temp (° C.) | 110 |
| Zone 2 Temp (° C.) | 140 |
| Zone 3 Temp (° C.) | 140 |
| Zone 4 Temp (° C.) | 140 |
| Zone 5 Temp (° C.) | 140 |
| Zone 6 Temp (° C.) | 150 |
| Screw Speed (rpm) | 225 |
| Water Bath Temp (° C.) | ~5 |
| Total Feed Rate (lbs/hr) | 25 |

Inventive Blend Composition 1-8 and Comparative Blend Compositions 1-6 were tested for their properties, and the results are reported in Tables 3A and 3B.

TABLE 3A

| | Inventive | Inventive | Inventive | Inventive | Inventive | Inventive | Inventive | Inventive |
|---|---|---|---|---|---|---|---|---|
| | Blend | Blend | Blend | Blend | Blend | Blend | Blend | Blend |
| | Comp 1 | Comp 2 | Comp 3 | Comp 4 | Comp 5 | Comp 6 | Comp 7 | Comp 8 |
| Density, | 0.87 | 0.87 | 0.87 | 0.87 | 0.87 | 0.87 | 0.89 | 0.88 |
| g/cc | | | | | | | | |
| T_{c} by | 85 | 77 | 81 | 85 | 92 | 84 | 92 | 84 |
| DSC, ° C. | | | | | | | | |
| ΔHₘ by | 28.2 | 27.3 | 24.9 | 32.6 | 30.1 | 25.1 | 17.5 | 24.3 |
| DSC, J/g | | | | | | | | |
| I2 at | 10.6 | 10.4 | 18.1 | 67.9 | 10.2 | 28 | 10 | 43 |
| 230° C., | | | | | | | | |
| 2.16 kg, | | | | | | | | |
| dg/min | | | | | | | | |

TABLE 3B

| | Comparative | Comparative | Comparative | Comparative | Comparative | Comparative |
|---|---|---|---|---|---|---|
| | Blend Comp 1 | Blend Comp 2 | Blend Comp 3 | Blend Comp 4 | Blend Comp 5 | Blend Comp 6 |
| Density, g/cc | 0.88 | 0.87 | 0.87 | 0.87 | — | 0.88 |
| T_{c} by DSC, | 77 | 106 | 88 | 88 | 85 | 86 |
| ° C. | | | | | | |
| ΔHₘ by DSC, | 33 | 36.9 | 17.8 | 17.8 | 17.8 | 22.8 |
| J/g | | | | | | |
| I2 at 230° C., | 9.7 | 11.1 | 13 | 12 | 2.9 | 77.8 |
| 2.16 kg, | | | | | | |
| dg/min | | | | | | |

As shown in Table 3A, the inventive blend compositions have sufficiently high I2 and sufficiently high Tc for good processability.

### Inventive Injection Molded Articles (IIMA) 1-8 and Comparative Injection Molded Articles (CIMA) 1-6

Inventive Blend Composition 1-8 and Comparative Blend Compositions 1-6 were injection molded into IIMA 1-7 and CIMA 1-4, i.e. plaques (4×6×0.125″), on a Krauss Maffei KM 110-390/390 CL Injection Molding Machine, equipped with a single shot mold base using conditions listed in Table 4.

TABLE 4

| | |
|---|---|
| Hopper Zone Temp (° C.) | 40 |
| Zone 1 Temperature (° C.) | 121 |
| Zone 2 Temperature (° C.) | 175 |
| Zone 3 Temperature (° C.) | 204 |
| Zone 4 Temperature (° C.) | 204 |
| Zone 5 Temperature (° C.) | 204 |
| Nozzle Temperature (° C.) | 200 |
| Mold Temperature (° C.) | 18 |
| Extruder Speed (rpm) | 150 |
| Extruder Backpressure (bar) | 15 |
| Dosage (ccm) | 75 |
| Injection Speed (ccm/s) | 40 |
| Injection Pressure (bar) | 2000 |
| Switch Over Position (ccm) | 15 |
| Hold Pressure (bar) | 250 |
| Hold Time (s) | 30 |
| Cool Time (s) | 30 |

IIMA 1-8 and CIMA 1-6 were tested for their properties, and the results are reported in Table 5A and 5B.

TABLE 5A

| | IIMA1 | IIMA2 | IIM3 | IIMA4 | IIMA5 | IIMA6 | IIMA7 | IIMA8 |
|---|---|---|---|---|---|---|---|---|
| Sh. A Hardness, | 68 | 68 | 63 | 75 | 68 | 61 | 72.6 | 56 |
| 10 sec | | | | | | | | |
| Haze, % | 18.4 | 16.3 | 18.8 | 21.8 | 18.3 | 22.8 | 20 | 26 |
| Haze after aging | 32.9 | 31.1 | 34.7 | 42.1 | — | 20.6 | 20.1 | 25 |
| 55° C. for five | | | | | | | | |
| days | | | | | | | | |
| TMA, −1000 | 101 | 98 | 102 | 82 | 116 | 101 | 112 | 98 |
| micron, ° C. | | | | | | | | |
| Fingerprint | 2 | 2 | 2 | 1 | 2 | — | — | — |
| Tensile Strength, | 6 | 6.9 | 6.2 | 9.7 | 6.9 | 5 | 9.3 | 4.5 |
| MPa | | | | | | | | |
| Elongation at | 543 | 578 | 638 | 973 | 591 | 380 | 633 | 479 |
| Break, % | | | | | | | | |
| Die C Tear | 42.6 | 41 | 37.9 | 47.8 | 36.6 | 36 | 53 | 27 |
| Strength, N/mm | | | | | | | | |

TABLE 5B

| | CIMA1 | CIMA2 | CIMA3 | CIMA4 | CIMA5 | CIMA6 |
|---|---|---|---|---|---|---|
| Sh. A | 87 | 63 | 67.2 | 68.5 | 83 | 51.5 |
| Hardness, | | | | | | |
| 10 sec | | | | | | |
| Haze, % | 53.4 | 99.6 | 29.4 | 31 | 23.8 | 28 |
| Haze after | 49.2 | 100 | 38.6 | 50.14 | — | 24.2 |
| aging 55° C. | | | | | | |
| for five | | | | | | |
| days | | | | | | |
| TMA, −1000 | 125 | 71 | 107 | 113 | 111 | 89 |
| micron, ° C. | | | | | | |
| Fingerprint | 3 | 1 | — | — | — | — |
| Tensile | 11.7 | 5.7 | 6.2 | 6.1 | 10.6 | 4.6 |
| Strength, | | | | | | |
| MPa | | | | | | |
| Elongation | 660 | 617 | 371 | 346 | 420 | 564 |
| at Break, % | | | | | | |
| Tear | 67.8 | 35 | 49 | 48 | 71 | 31 |
| Strength, | | | | | | |
| Die C, | | | | | | |
| N/mm | | | | | | |

As shown in Table 5A, the inventive blend compositions have sufficiently low hardness; low haze; and an absence of oil bleed out, as indicated by low haze of the injection molded article after heat aging; as compared to the comparative compositions in Table 5B. Thus, the inventive blend compositions have improved properties as compared to the comparative blend compositions.

### Test Methods

Test methods include the following:

Density (g/cm³) was measured according to ASTM-D 792-03, Method B, in isopropanol. Specimens were measured in the isopropanol bath at 23° C. for 8 min to achieve thermal equilibrium prior to measurement.

Melt index (I₂) was measured at either 190° C. or 230° C. under a load of 2.16 kg according to ASTM D-1238-03.

Shore A hardness was tested as per ASTM D2240 on a Shore A electric durometer. Weight was applied for 10 seconds.

Haze was measured on 0.125″ thick injection molded plaques according to ASTM D-1003.

DSC crystallization point temperature (T_{c}) is derived from DSC cooling curve.

Heat of fusion is derived from DSC melting curve.

Weight percent crystallinity is measured via Differential Scanning calorimetry (DSC).

Differential Scanning calorimetry (DSC) is based on the following. All of the results reported here were generated via a TA Instruments Model Q1000 DSC equipped with an RCS (refrigerated cooling system) cooling accessory and an auto sampler. A nitrogen purge gas flow of 50 ml/min was used throughout. The sample was pressed into a thin film using a press at 175° C., and 1500 psi (10.3 MPa) maximum pressure, for about 15 seconds, then air-cooled to room temperature at atmospheric pressure. About 3 to 10 mg of material was then cut into a 6 mm diameter disk using a paper hole punch, weighed to the nearest 0.001 mg, placed in a light aluminum pan (ca 50 mg), and then crimped shut. The thermal behavior of the sample was investigated with the following temperature profile. The sample was rapidly heated to 180° C., and held isothermal for 3 minutes in order to remove any previous thermal history. The sample was then cooled to −80° C. at 10° C./min cooling rate, and was held at −80° C. for 3 minutes. The sample was then heated to 180° C. at 10° C./min heating rate. The cooling and second heating curves were recorded.

Thermomechanical Analysis (TMA) was conducted on the injection molded samples using a TA Instruments 2940 Thermomechanical Analyzer instrument, equipped with a 0.89 mm contact diameter probe. A force of 1 N was applied to a sample approximately 0.2″×0.2″ cut from the 0.125″ thick injection molded plaque. Testing was initiated at room temperature, and the temperature increased at 5° C./min. The temperature at which the probe penetrated 1000 microns into the sample was reported.

The tackiness of each injection molded samples was evaluated using a qualitative fingerprint test. The appearance of fingerprints on the surface of injection molded plaques was determined by applying even, firm pressure with the thumb for 5 s to a plaque, after heat aging at 70° C. for 7 days. The appearance of a fingerprint was evaluated using the following scale: 1=no visible fingerprint, 2=marginally visible fingerprint, and 3=clearly visible fingerprint.

Tensile testing was conducted according to ASTM D1708. Microtensile specimens were cut from the injection molded plaques.

C-Tear testing was performed according to ASTM D624. C-tear specimens were cut from the injection molded plaques.

The present invention may be embodied in other forms, without departing from the spirit and the essential attributes thereof, and, accordingly, reference should be made to the appended claims, rather than to the foregoing specification, as indicating the scope of the invention.

1. A blend composition suitable for injection molding applications comprising:
(a) from 50 to 80 percent by weight of a propylene/α-olefin interpolymer composition;
(b) from 5 to 25 percent by weight of a homopolymer polypropylene, a random copolymer polypropylene, clarified random copolymer polypropylene, and combination thereof; and
(c) from 5 to 39 percent by weight of a plasticizing agent;
wherein said blend composition has a total haze of less than 25 percent.

2. A process for making an injection molded article comprising the steps of:
(a) selecting from 50 to 80 percent by weight of a propylene/α-olefin interpolymer composition;
(b) selecting from 5 to 25 percent by weight of a homopolymer polypropylene, a random copolymer polypropylene, clarified random copolymer polypropylene, and combination thereof; and
(c) selecting from 5 to 35 percent by weight of a plasticizing agent;
(d) contacting said a-c components in the presence of heat;
(e) thereby forming a blend composition, wherein said blend composition has a total haze of less than 25 percent; and
(f) forming said blend composition into a molded article.

3. The blend composition of claim 1, wherein said plasticizing agent has a viscosity in the range of from 12 to 70 cSt at 40° C., measured according to ASTM D-445.

4. The process for making an injection molded article of claim 2 further comprising the step of selecting a mold release agent, and contacting said a-c components and said mold release agent in the presence of heat; thereby forming a blend composition, wherein said blend composition has a total haze of less than 25 percent; and forming said blend composition into a molded article.

5. The blend composition of claim 1, wherein said blend composition further comprises a mold release agent.

6. The blend composition of claim 5, wherein said mold release agent comprises an Oleamide.

7. The blend composition of claim 6, wherein the Oleamide is 9-Octadecenamide.

8. The blend composition of claim 6, wherein said Oleamide has the following molecular structure:

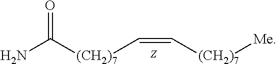

9. The blend composition of claim 1, wherein the blend composition has a Hardness, Shore A in the range of from 50 to 90.

10. The blend composition of claim 1, wherein the blend composition has a melt flow rate, measured at 190° C. and 2.16 kg, in the range of from 8 to 70 g/10 minutes.

11. The blend composition of claim 1, wherein the blend composition has a fingerprint, after aging at 70° C. for one week, of 1 or 2.

12. A molded article comprising the blend composition of claim 1.

13. An article comprising the blend composition of claim 3 having a haze of less than 25% after said article being aged in an oven at 55° C., or above, for at least 5 consecutive days.

14. The process of making an injection molded article of claim 4, wherein said mold release agent comprises an Oleamide.

15. The process of making an injection molded article of claim 2, wherein said plasticizing agent has a viscosity in the range of from 12 to 70 cSt at 40° C., measured according to ASTM D-445.
